(19) United States
(12) Patent Application Publication
(10) Pub. No.: US 2024/0101817 A1
(43) Pub. Date: Mar. 28, 2024

(54) STABILIZING A SHAPED POLYMER ARTICLE AGAINST DEGRADATION INDUCED BY ARTIFICIAL UV-C LIGHT

(71) Applicant: BASF SE, Ludwigshafen (DE)

(72) Inventors: Gregor HUBER, Kaisten (CH); Heinz HERBST, Kaisten (CH)

(21) Appl. No.: 18/270,772

(22) PCT Filed: Jan. 3, 2022
(86) PCT No.: PCT/EP2022/050031

§ 371 Date: Jul. 3, 2023

(30) Foreign Application Priority Data
Jan. 5, 2021 (EP) 21150245.5

(51) Int. Cl. C08L 69/00; C08K 5/07; C08K 5/105; C08K 5/3475; C08K 5/3492; C08K 5/357; C08L 23/06; C08L 23/12

(52) U.S. Cl. CPC C08L 69/00; C08K 5/07; C08K 5/105; C08K 5/3475; C08K 5/3492; C08K 5/357; C08L 23/06; C08L 23/12; C08L 2207/062; C08L 2207/066

(57) ABSTRACT

The present invention relates to a use of a stabilizer selected from compound (1) to (23) or micronized metal oxide salts for stabilizing a shaped polymer article against degradation induced by artificial UV-C light; and to a method for stabilizing a shaped polymer article against degradation induced by artificial UV-C light, which comprises incorporating into the shaped polymer articles a stabilizer selected from the stabilizers.

The present invention relates to a use of a stabilizer selected from compound (1) to (23) or micronized metal oxide salts for stabilizing a shaped polymer article against degradation induced by artificial UV-C light; and to a method for stabilizing a shaped polymer article against degradation induced by artificial UV-C light, which comprises incorporating into the shaped polymer articles a stabilizer selected from the stabilizers.

Artificial UV-C light is increasingly used for disinfection of polymer articles. As a result an increase of yellowing, microcracks, or blooming was observed in such polymer articles. Thus, there is a need for the development of suitable plastic additives which offer a low application rate, which are compatible with other plastic additives, and which reduce yellowing, microcracks, or blooming.

The objects were achieved by a use of a stabilizer selected from

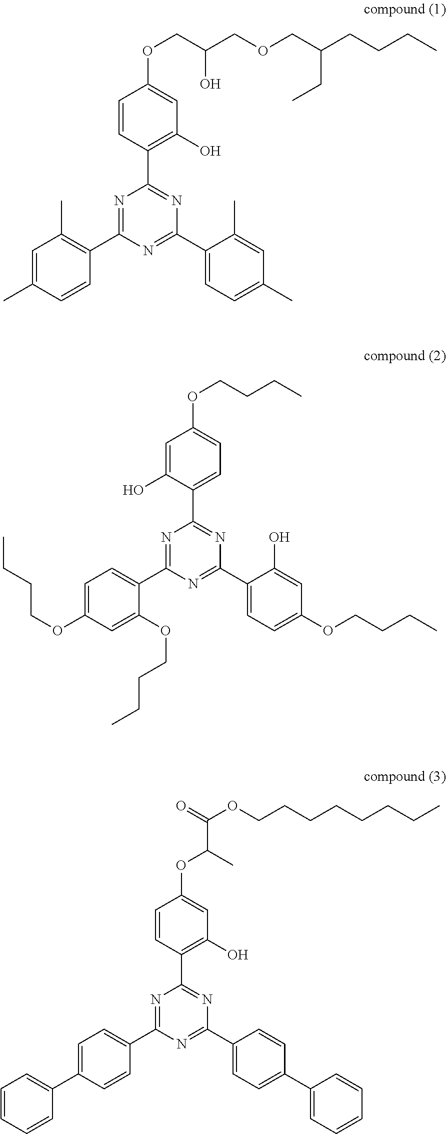 [SMILES: CCCCC(CC)COCC(O)COc1ccc(-c2nc(-c3ccc(C)cc3C)nc(-c3ccc(C)cc3C)n2)c(O)c1 ; CCCCOc1ccc(-c2nc(-c3ccc(OCCCC)cc3O)nc(-c3ccc(OCCCC)cc3OCCCC)n2)c(O)c1 ; CCCCCCCCOC(=O)C(C)Oc1ccc(-c2nc(-c3ccc(-c4ccccc4)cc3)nc(-c3ccc(-c4ccccc4)cc3)n2)c(O)c1]

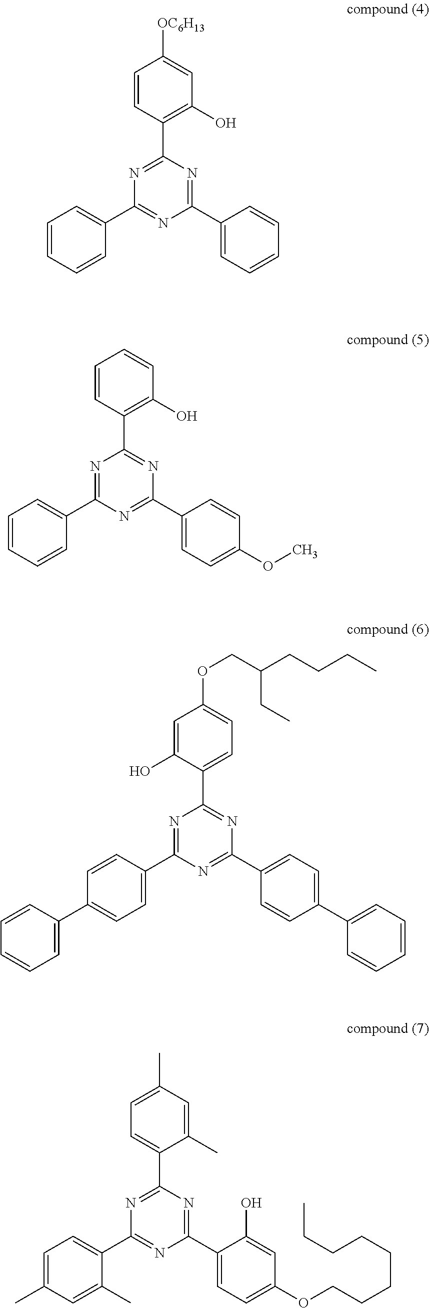

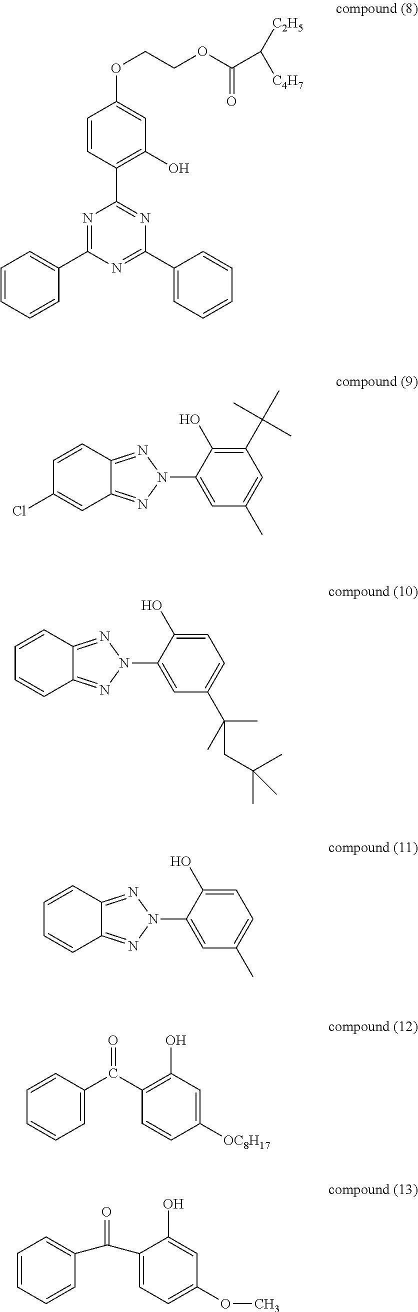

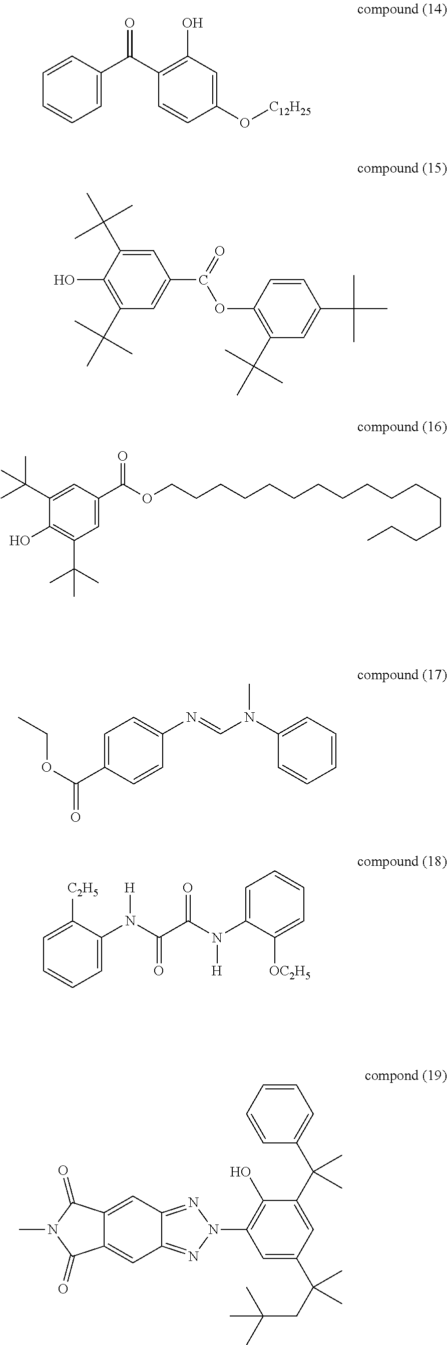

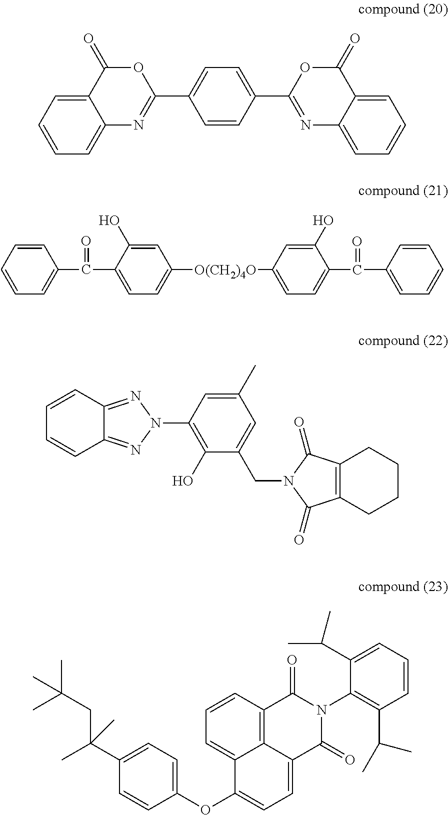

or
micronized metal oxide salts
for stabilizing a shaped polymer article against degradation induced by artificial UV-C light.

The objects were also achieved by a method for stabilizing a shaped polymer article against degradation induced by artificial UV-C light, which comprises incorporating into the shaped polymer articles a stabilizer selected from the compounds (1) to (23) or micronized metal oxide salts.

Suitable micronized metal oxide salts are titanium dioxide, zinc oxide, oxides of iron, of zirconium, of silicon, of manganese, of aluminum or of cerium. Preferred micronized metal oxide salts are titanium dioxide and zinc oxide. The micronized metal oxide salts can be coated or uncoated. The particles of the micronized metal oxide salts may have a mean diameter of less than 100 nm, preferably between 5 and 50 nm and especially between 15 and 30 nm. They may have a spherical shape, but it is also possible to use those particles which have an ellipsoidal shape or a shape which deviates in some other way from the spherical configuration.

Preferably, the stabilizer is selected from
compound (4),
compound (15),
compound (16), and
micronized metal oxide salts, such as titanium dioxide and zinc oxide.

In another preferred form the stabilizer is selected from compound (1), compound (2), compound (3), compound (4), compound (5), compound (6), compound (7), compound (8), compound (9), compound (10), compound (11), compound (12), compound (13), compound (14), compound (15), compound (16), compound (17), compound (18), compound (19), compound (20), compound (21), compound (22), compound (23), and mixtures thereof.

In another preferred form the stabilizer is selected from compound (1), compound (2), compound (3), compound (4), compound (5), compound (6), compound (7), compound (8), compound (9), compound (10), compound (11), compound (12), compound (13), compound (14), compound (15), compound (16), compound (17), compound (18), compound (19), compound (20), compound (21), compound (22), compound (23), a mixture of compound (12) and compound (4), a mixture of compound (11) and compound (9), and a mixture of compound (11) and compound (10).

In another preferred form the stabilizer is selected from
compound (6),
compound (7),
compound (10),
compound (11),
compound (12),
compound (16),
a mixture of compound (12) and compound (4),
a mixture of compound (11) and compound (9), and
a mixture of compound (11) and compound (10).

In another preferred form the stabilizer is selected from compound (1).

In another preferred form the stabilizer is selected from compound (2).

In another preferred form the stabilizer is selected from compound (3).

In another preferred form the stabilizer is selected from compound (4).

In another preferred form the stabilizer is selected from compound (5).

In another preferred form the stabilizer is selected from compound (6).

In another preferred form the stabilizer is selected from compound (7).

In another preferred form the stabilizer is selected from compound (8).

In another preferred form the stabilizer is selected from compound (9).

In another preferred form the stabilizer is selected from compound (10).

In another preferred form the stabilizer is selected from compound (11).

In another preferred form the stabilizer is selected from compound (12).

In another preferred form the stabilizer is selected from compound (13).

In another preferred form the stabilizer is selected from compound (14).

In another preferred form the stabilizer is selected from compound (15).

In another preferred form the stabilizer is selected from compound (16).

In another preferred form the stabilizer is selected from compound (17).

In another preferred form the stabilizer is selected from compound (18).

In another preferred form the stabilizer is selected from compound (19).

In another preferred form the stabilizer is selected from compound (21).

In another preferred form the stabilizer is selected from compound (22).

In another preferred form the stabilizer is selected from compound (23).

In another preferred form the stabilizer is selected from micronized metal oxide salts, such as titanium dioxide and zinc oxide.

Mixtures of the stabilizer are also possible. Usually, a mixture of the stabilizers comprises two of the stabilizers. A mixture of two stabilizers may comprise them in a weight ratio of from 10:1 to 1:10, preferably from 7:1 to 1:7.

In another preferred form the stabilizer is selected from a mixture of compound (12) and compound (4), and a mixture of compound (11) and compound (9), and a mixture of compound (11) and compound (10).

In another preferred form the stabilizer is selected from a mixture of compound (12) and compound (4), where the weight ratio can be from 10:1 to 1:10, preferably from 7:1 to 1:7.

In another preferred form the stabilizer is selected from a mixture of compound (11) and compound (9), where the weight ratio can be from 10:1 to 1:10, preferably from 7:1 to 1:7.

In another preferred form the stabilizer is selected from a mixture of compound (11) and compound (10), where the weight ratio can be from 10:1 to 1:10, preferably from 7:1 to 1:7.

In another preferred form the stabilizer is selected from a mixture of compound (1) and a further stabilizer selected from compounds (2) to (23), and where the weight ratio can be from 10:1 to 1:10, preferably from 7:1 to 1:7.

In another preferred form the stabilizer is selected from a mixture of compound (2) and a further stabilizer selected from compounds (1) to (23), and where the weight ratio can be from 10:1 to 1:10, preferably from 7:1 to 1:7.

In another preferred form the stabilizer is selected from a mixture of compound (3) and a further stabilizer selected from compounds (1) to (23), and where the weight ratio can be from 10:1 to 1:10, preferably from 7:1 to 1:7.

In another preferred form the stabilizer is selected from a mixture of compound (4) and a further stabilizer selected from compounds (1) to (23), and where the weight ratio can be from 10:1 to 1:10, preferably from 7:1 to 1:7.

In another preferred form the stabilizer is selected from a mixture of compound (5) and a further stabilizer selected from compounds (1) to (23), and where the weight ratio can be from 10:1 to 1:10, preferably from 7:1 to 1:7.

In another preferred form the stabilizer is selected from a mixture of compound (6) and a further stabilizer selected from compounds (1) to (23), and where the weight ratio can be from 10:1 to 1:10, preferably from 7:1 to 1:7.

In another preferred form the stabilizer is selected from a mixture of compound (7) and a further stabilizer selected from compounds (1) to (23), and where the weight ratio can be from 10:1 to 1:10, preferably from 7:1 to 1:7.

In another preferred form the stabilizer is selected from a mixture of compound (8) and a further stabilizer selected from compounds (1) to (23), and where the weight ratio can be from 10:1 to 1:10, preferably from 7:1 to 1:7.

In another preferred form the stabilizer is selected from a mixture of compound (9) and a further stabilizer selected from compounds (1) to (23), and where the weight ratio can be from 10:1 to 1:10, preferably from 7:1 to 1:7.

In another preferred form the stabilizer is selected from a mixture of compound (10) and a further stabilizer selected from compounds (1) to (23), and where the weight ratio can be from 10:1 to 1:10, preferably from 7:1 to 1:7.

In another preferred form the stabilizer is selected from a mixture of compound (11) and a further stabilizer selected from compounds (1) to (23), and where the weight ratio can be from 10:1 to 1:10, preferably from 7:1 to 1:7.

In another preferred form the stabilizer is selected from a mixture of compound (12) and a further stabilizer selected from compounds (1) to (23), and where the weight ratio can be from 10:1 to 1:10, preferably from 7:1 to 1:7.

In another preferred form the stabilizer is selected from a mixture of compound (13) and a further stabilizer selected from compounds (1) to (23), and where the weight ratio can be from 10:1 to 1:10, preferably from 7:1 to 1:7.

In another preferred form the stabilizer is selected from a mixture of compound (14) and a further stabilizer selected from compounds (1) to (23), and where the weight ratio can be from 10:1 to 1:10, preferably from 7:1 to 1:7.

In another preferred form the stabilizer is selected from a mixture of compound (15) and a further stabilizer selected from compounds (1) to (23), and where the weight ratio can be from 10:1 to 1:10, preferably from 7:1 to 1:7.

In another preferred form the stabilizer is selected from a mixture of compound (16) and a further stabilizer selected from compounds (1) to (23), and where the weight ratio can be from 10:1 to 1:10, preferably from 7:1 to 1:7.

In another preferred form the stabilizer is selected from a mixture of compound (17) and a further stabilizer selected from compounds (1) to (23), and where the weight ratio can be from 10:1 to 1:10, preferably from 7:1 to 1:7.

In another preferred form the stabilizer is selected from a mixture of compound (18) and a further stabilizer selected from compounds (1) to (23), and where the weight ratio can be from 10:1 to 1:10, preferably from 7:1 to 1:7.

In another preferred form the stabilizer is selected from a mixture of compound (19) and a further stabilizer selected from compounds (1) to (23), and where the weight ratio can be from 10:1 to 1:10, preferably from 7:1 to 1:7.

In another preferred form the stabilizer is selected from a mixture of compound (20) and a further stabilizer selected from compounds (1) to (23), and where the weight ratio can be from 10:1 to 1:10, preferably from 7:1 to 1:7.

In another preferred form the stabilizer is selected from a mixture of compound (21) and a further stabilizer selected from compounds (1) to (23), and where the weight ratio can be from 10:1 to 1:10, preferably from 7:1 to 1:7.

In another preferred form the stabilizer is selected from a mixture of compound (22) and a further stabilizer selected from compounds (1) to (23), and where the weight ratio can be from 10:1 to 1:10, preferably from 7:1 to 1:7.

In another preferred form the stabilizer is selected from a mixture of compound (23) and a further stabilizer selected from compounds (1) to (22), and where the weight ratio can be from 10:1 to 1:10, preferably from 7:1 to 1:7.

The shaped polymer article comprises usually 0.01-1 wt %, preferably 0.1-0.5 wt % of the stabilizer.

The stabilizer is usually present inside the shaped polymer article, e.g. it is evenly distributed inside the shaped polymer article.

The artificial UV-C light can have a wavelength from 100 to 290 nm, preferably from 200 to 275 nm. For example the UV-C light has a wavelength of 250-260 nm, or 220-230 nm, or 210-220 nm, or 260-270 nm, or 200-220 nm.

The UV-C light is artificial, which usually means it is produced by lamps, such as mercury lamps, excimer lamps, pulsed xenon lamps, or light-emitting diodes (LED).

The degradation is usually induced by UV-C disinfection against microorganisms of the shaped polymer article. UV-C disinfection is a method to disinfect a surface by irradiating it with the artificial UV-C light.

The UV-C disinfection typically results in a decrease of microorganism, such as archaea, bacteria, fungi, protozoa, or viruses. When a microorganism is exposed to UV-C light, the nuclei of the cells can be modified due to photolytic processes. In result, cell division and, by extension, reproduction can be prevented.

Examples of bacteria are the following genus: Chlamydia, Clostridium, Escherichia, Helicobacterium, Lactobacillus, Legionella, Leuconostoc, Listeria, Pediococcus, Salmonella, Shigella, Staphylococcus, Vibrio and Yersinia.

Examples of fungi are the following genus: Aspergillus, Penicillium, Saccharomyches and Candida.

Examples of viruses are the following genus and groups: Coronavirus (e.g. SARS-CoV-1 (severe acute respiratory syndrome coronavirus), MERS-CoV (Middle East respiratory syndrome coronavirus), SARS-CoV-2), Rotavirus, Norovirus, Human papilloma virus, Herpes virus, Hepatitis virus, Influenza virus and HIV.

UV-C disinfection of surfaces requires usually a high intensity of UV-C light and the lamps are typically close to the surface which are kept free from microorganisms.

The dose of the UV-C light usually determines the effectiveness of the UV-C disinfection. The dose is the product of UV intensity (expressed as energy per unit surface area, e.g. micro Watt per cm2) and exposure time (e.g. seconds). The dose is commonly expressed as 1 mJ/cm2=1000 micro Watt second/cm2.

Doses for a 90% kill of most bacteria and viruses range according to literature usually between 2,000 and 8,000 μW·s/cm2. Some typical doses (mJ/cm2) can be found in literature to control some microorganisms:
Bacillus subtilis (spore) 12.0
Clostridium tetani 4.9
Legionella pneumophilla 2.04
Pseudonomas aeruginosa 5.5
Streptococcus feacalis 4.5
Hepatitis A virus 11.0
Hepatitis Poliovirus 12.0
Saccharomyces cervisiae 6.0
Infectious pancreatic necrosis 60.0

In general a dose of the UV-C light of at least 100, 500, 1000, 1500, 2000, 3000, or 5000 μW·s/cm2 within 24 h is received at the surface of the shaped polymer article. For example the surface receives each day a dose of at least 500 μW·s/cm2, such as a surface in a subway, which is disinfected with UV-C light each early morning, or a surface in a taxi, which is disinfected with doses of UV-C light after each passenger in a day.

The degradation by UV-C light, preferably induced by UV-C disinfection, is usually induced frequently, for example at least once a second, a minute, an hour, a day, or a week.

The degradation by UV-C light is usually induced indoors, such as in public buildings (e.g. schools, hospitals, libraries), industrial offices (open plan offices, cubicles), industrial production buildings (warehouses, assembly halls), private buildings (single family houses, multistory houses, skyscraper), or in transport vehicles (cars, taxis, bus, trams, underground railway, trains, airplanes, ships).

The shaped polymer articles is usually an articles which is present indoors, such as in public buildings (e.g. schools, hospitals, libraries), industrial offices (open plan offices, cubicles), industrial production buildings (warehouses, assembly halls), private buildings (single family houses, multistory houses, skyscraper), or in transport vehicles (cars, taxis, bus, trams, underground railway, trains, airplanes, ships).

Suitable shaped polymer articles are:
Articles in transport vehicles, e.g. dashboards, hat shelf, seats, trunk linings, interior linings, panes for dashboards, instrument panel, upholstery, door panels, seat backing, pillar covers, fasteners, consoles, instrument panels, seats, frames, skins;
Appliances, e.g. cases and coverings in general, electronic devices (personal computer, telephone, portable phone, printer, television-sets, audio and video devices), or electric appliances, (e.g. washing machines, tumblers, ovens (microwave oven), dish-washers, mixers, and irons);
Sanitary articles, e.g. mobile toilets, shower cubicles, lavatory seats, covers, sinks, shower curtains, brushes, mats, tubs, mobile toilets, tooth brushes, and bed pans;
Fabrics, e.g. carpets, curtains, shades, nets, ropes, cables, strings, cords, threads, clothes, underwear, gloves, shoes, sportswear, umbrellas, tents, airbeds, bags;
Storage systems such as boxes (crates), luggage, bottles, chest, household boxes, pallets, container, shelves, tracks, screw boxes, packs, and cans.
Medical devices such as piston, plastic syringes, ophthalmic applications, diagnostic devices, and packing for pharmaceuticals blister.
Furniture, e.g. foamed articles (cushions, impact absorbers), dish clothes, mats, chairs, tables, couches;
Office supplies, e.g. ball-point pens, ink-pads, mouse, shelves, tracks.

The shaped polymer article is usually a non-transparent article.

The shaped polymer article has usually at least in part a non-porous surface.

In general a non-porous surface of the shaped polymer article is stabilized against the degradation.

Typically, a non-transparent surface of the shaped polymer article is stabilized against the degradation.

The stabilizing against degradation usually comprises
a reduction of yellowing of the shaped article, or
a reduction of microcracks on the surface of the shaped article, or
a reduction of blooming of the shaped article.

The reduction may be determined in comparison to a shaped polymer article which is free of the stabilizer. The stabilizer may stabilize the area of the shaped article which is exposed to the UV-C light.

The shaped polymer articles is usually made of a synthetic polymer. Examples of synthetic polymer are:

1. Polymers of monoolefins and diolefins, for example polypropylene, polyisobutylene, polybut-1-ene, poly-4-methylpent-1-ene, polyvinylcyclohexane, polyisoprene or poly-butadiene, polyhexene, polyoctene, as well as polymers of cycloolefins, for instance of cyclopentene, cyclohexene, cyclooctene or nor-bornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single-site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), very low density polyethylene, propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C5-C9) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included. Copolymers from 1.)-4.) may by random or block-copolymers, homo- or heterophasic, or High Crystalline Homopolymer.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/isoprene/butadiene/styrene, styrene/ethylene/butylene/styrene or styrene/ethylene/propylene/styrene, HIPS, ABS, ASA, AES.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride (PVC), polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers. Polyvinyl chloride may be rigid or flexible (plasticized).

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or poly-butadienes on the one hand and aliphatic or aromatic polyisocyanates on the other, as well as precursors thereof. Polyurethanes formed by the reaction of: (1) diisocyanates with short-chain diols (chain extenders) and (2) diisocyanates with long-chain diols (thermoplastic polyurethanes, TPU).

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems). The polyamides may be amorphous.

17. Polyureas, polyimides, polyamideimides, polyetherimides, polyesterimides, polyhydantoins and polybenzimidazoles.

18. Polyesters derived from dicarboxylic acids and diols and/or from hydroxycarboxylic acids or the corresponding lactones or lactides, for example polyethylene terephthalate (PET), polybutylene terephthalate, poly-1,4-dimethylolcyclohexane terephthalate, polypropylene terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutyl-enesuccinate/terephtalate, polybutyleneadipate/terephthalate, polytetramethyleneadipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate, polyethylene furanoate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lactide and any mixtures thereof. Preferred polyesters are PET, PET-G, PBT.

19. Polycarbonates and polyester carbonates. The polycarbonates are preferably prepared by reaction of bisphenol compounds with carbonic acid compounds, in particular phosgene or, in the melt transesterification process, diphenyl carbonate or dimethyl carbonate.

Homopolycarbonates based on bisphenol A and copolycarbonates based on the monomers bisphenol A and 1,1-bis-(4-hydroxyphenyl)-3,3,5-trimethylcyclohexane (bisphenol TMC) are particularly preferred. These and further bisphenol and diol compounds which can be used for the polycarbonate synthesis are disclosed inter alia in WO08037364 (p.7, line 21 to p.10, line 5), EP1582549 ([0018] to [0034]), WO02026862 (p.2, line 23 to p.-5, line 15), WO05113639 (p. 2, line 1 to p.7, line 20). The polycarbonates can be linear or branched. Mixtures of branched and unbranched polycarbonates can also be used. Suitable branching agents for polycarbonates are known from the literature and are described, for example, in patent specifications U.S. Pat. No. 4,185,009 and DE2500092 (3,3-bis-(4-hydroxyaryl-oxindoles according to the invention, see whole document in each case), DE4240313 (see p.3, line 33 to 55), DE19943642 (see p.5, line 25 to 34) and U.S. Pat. No. 5,367,044 as well as in literature cited therein. The polycarbonates used can additionally be intrinsically branched, no branching agent being added here within the context of the polycarbonate preparation. An example of intrinsic branchings are so-called Fries structures, as are disclosed for melt polycarbonates in EP1506249. Chain terminators can additionally be used in the polycarbonate preparation. Phenols such as phenol, alkylphenols such as cresol and 4-tert-butylphenol, chlorophenol, bromophenol, cumylphenol or mixtures thereof are preferably used as chain terminators. Polyester carbonates are obtained by reaction of the bisphenols already mentioned, at least one aromatic dicarboxylic acid and optionally carbonic acid equivalents. Suitable aromatic dicarboxylic acids are, for example, phthalic acid, terephthalic acid, isophthalic acid, 3,3′- or 4,4′-diphenyldicarboxylic acid and benzophenone-dicarboxylic acids. A portion, up to 80 mol-%, preferably from 20 to 50 mol-%, of the carbonate groups in the polycarbonates can be replaced by aromatic dicarboxylic acid ester groups.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A, bisphenol E and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and co-polymers, PA/HDPE, PA/PP, PA/PPO, PBT/PC/ABS or PBT/PET/PC.

30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

31. Aqueous emulsions of natural or synthetic rubber, e.g. natural latex or latices of carboxylated styrene/butadiene copolymers.

32. Adhesives, for example block copolymers such as SIS, SBS, SEBS, SEPS (S represents styrene, I isoprene, B polybutadiene, EB ethylene/butylene block, EP polyethylene/polypropylene block).

33. Rubbers, for example polymers of conjugated dienes, e.g. polybutadiene or polyisoprene, copolymers of mono- and diolefins with one another or with other vinyl monomers, copolymers of styrene or α-methylstyrene with dienes or with acrylic derivatives, chlorinated rubbers, natural rubber.

34. Elastomers, for example natural polyisoprene (cis-1,4-polyisoprene natural rubber (NR) and trans-1,4-polyisoprene gutta-percha), Synthetic polyisoprene (IR for isoprene rubber), Polybutadiene (BR for butadiene rubber), Chloroprene rubber (CR), polychloroprene, Neoprene, Baypren etc., Butyl rubber (copolymer of isobutylene and isoprene, IIR), Halogenated butyl rubbers (chloro butyl rubber: CIIR; bromo butyl rubber: BIIR), Styrene-butadiene Rubber (copolymer of styrene and butadiene, SBR), Nitrile rubber (copolymer of butadiene and acrylonitrile, NBR), also called Buna N rubbers Hydrogenated Nitrile Rubbers (HNBR) Therban and Zetpol, EPM (ethylene propylene rubber, a copolymer of ethylene and propylene) and EPDM rubber (ethylene propylene diene rubber, a terpolymer of ethylene, propylene and a diene-component), Epichlorohydrin rubber (ECO), Polyacrylic rubber (ACM, ABR), Silicone rubber (SI, Q, VMQ), Fluorosilicone Rubber (FVMQ), Fluoroelastomers (FKM, and FEPM) Viton, Tecnoflon, Fluorel, Aflas and Dai-El, Perfluoroelastomers (FFKM) Tecnoflon PFR, Kalrez, Chemraz, Perlast, Polyether block amides (PEBA), Chlorosulfonated polyethylene (CSM), (Hypelon), Ethylene-vinyl acetate (EVA), Thermoplastic elastomers (TPE), The proteins resilin and elastin, Polysulfide rubber, Elastolefin, elastic fiber used in fabric production.

35. Thermoplastic elastomers, for example Styrenic block copolymers (TPE-s), Thermoplastic olefins (TPE-o), Elastomeric alloys (TPE-v or TPV), Thermoplastic polyurethanes (TPU), Thermoplastic copolyester, Thermoplastic polyamides, Reactor TPO's (R-TPO's), Polyolefin Plastomers (POP's), Polyolefin Elastomers (POE's).

Preferred synthetic polymers are polymers of above classes 1, 5, 6, 6a, 6b, 6c, 7, 8, 16, 18 and 19.

In another preferred form the synthetic polymers are polyethylenes, polypropylenes, polystyrenes, acrylonitrile butadiene styrene copolymer (ABS), or polycarbonates.

In another preferred form the synthetic polymers are polyethylenes, polypropylenes, polystyrenes, acrylonitrile butadiene styrene copolymer, polycarbonates, polyvinyl chlorides, polyamides or polyethylene terephthalates.

In another preferred form the synthetic polymers are polyethylenes.

In another preferred form the synthetic polymers are polypropylenes.

In another preferred form the synthetic polymers are polystyrenes

In another preferred form the synthetic polymers are acrylonitrile butadiene styrene copolymer.

In another preferred form the synthetic polymers are polycarbonates.

In another preferred form the synthetic polymers are polyvinyl chlorides.

In another preferred form the synthetic polymers are polyamides.

In another preferred form the synthetic polymers are polyethylene terephthalates.

In a preferred form, in case the stabilizer is the compound (4) then the shaped polymer article is made of polystyrenes, acrylonitrile butadiene styrene copolymers, polycarbonates, polyvinyl chlorides, polyamides or polyethylene terephthalates.

In another preferred form, in case the stabilizer is the compound (4) then the shaped polymer article is made of polystyrenes, acrylonitrile butadiene styrene copolymers, polycarbonates, polyvinyl chlorides, polyamides or polyethylene terephthalates.

In a preferred form the stabilizer is selected from compound (12), compound (4), compound (6), compound (7), compound (16), or a mixture of compound (12) and compound (4) (e.g. in a weight ratio from 10:1 to 1:10, preferably from 7:1 to 1:7), and the shaped polymer article is made of polyethylenes or polypropylenes.

In another preferred form the stabilizer is selected from compound (12) and the shaped polymer article is made of polyethylenes or polypropylenes.

In another preferred form the stabilizer is selected from compound (4) and the shaped polymer article is made of polyethylenes or polypropylenes.

In another preferred form the stabilizer is selected from compound (6) and the shaped polymer article is made of polyethylenes or polypropylenes.

In another preferred form the stabilizer is selected from compound (7) and the shaped polymer article is made of polyethylenes or polypropylenes.

In another preferred form the stabilizer is selected from compound (16) and the shaped polymer article is made of polyethylenes or polypropylenes.

In another preferred form the stabilizer is selected from a mixture of compound (12) and compound (4) (e.g. in a weight ratio from 10:1 to 1:10, preferably from 7:1 to 1:7), and the shaped polymer article is made of polyethylenes or polypropylenes.

In another preferred form the stabilizer is selected from compound (4), compound (10), compound (11), a mixture of compound (11) and compound (9) (e.g. in a weight ratio from 10:1 to 1:10, preferably from 7:1 to 1:7), or a mixture of compound (11) and compound (10) (e.g. in a weight ratio from 10:1 to 1:10, preferably from 7:1 to 1:7), and the shaped polymer article is made of acrylonitrile butadiene styrene copolymers.

In another preferred form the stabilizer is selected from compound (4) and the shaped polymer article is made of acrylonitrile butadiene styrene copolymers.

In another preferred form the stabilizer is selected from compound (10) and the shaped polymer article is made of acrylonitrile butadiene styrene copolymers.

In another preferred form the stabilizer is selected from compound (11) and the shaped polymer article is made of acrylonitrile butadiene styrene copolymers.

In another preferred form the stabilizer is selected from a mixture of compound (11) and compound (9) (e.g. in a weight ratio from 10:1 to 1:10, preferably from 7:1 to 1:7) and the shaped polymer article is made of acrylonitrile butadiene styrene copolymers.

In another preferred form the stabilizer is selected from a mixture of compound (11) and compound (10) (e.g. in a weight ratio from 10:1 to 1:10, preferably from 7:1 to 1:7), and the shaped polymer article is made of acrylonitrile butadiene styrene copolymers.

In another preferred form the stabilizer is selected from compound (4) or compound (10), and the shaped polymer article is made of polycarbonate and acrylonitrile butadiene styrene copolymer.

In another preferred form the stabilizer is selected from compound (4), and the shaped polymer article is made of polycarbonate and acrylonitrile butadiene styrene copolymer.

In another preferred form the stabilizer is selected from compound (10), and the shaped polymer article is made of polycarbonate and acrylonitrile butadiene styrene copolymer.

The shaped polymer article is for example prepared or shaped by one of the following processing steps:
Injection blow molding, extrusion, blow molding, rotomolding, in mold decoration (back injection), slush molding, injection molding, co-injection molding, blow molding, forming, compression molding, resin transfer molding, pressing, film extrusion (cast film; blown film), fiber spinning (woven, non-woven), drawing (uniaxial, biaxial), annealing, deep drawing, calendering, mechanical transformation, sintering, coextrusion, lamination, crosslinking (radiation, peroxide, silane), vapor deposition, weld together, glue, vulcanization, thermoforming, pipe extrusion, profile extrusion, sheet extrusion; sheet casting, strapping, foaming, recycling/rework, visbreaking (peroxide, thermal), fiber melt blown, spun bonded, surface treatment (corona discharge, flame, plasma), sterilization (by gamma rays, electron beams), tape extrusion, pulltrusion, SMC-process or plastisol.

The shaped polymer article can be an extruded, molded or calendered shaped polymer article.

The shaped polymer articles may have any shape, such as a film, foil, fibre, fabric, plate, device.

### EXAMPLES

### Example 1—LDPE Cast Films

A Linear Low Density Polyethylene (Dowlex® SC 2107GC of 0.917 g/cm³ density (ASTM D792) and Melt Index of 2.3 g/10 min @ 190° C./2.16 kg (ASTM D1238)) was formulated with 200 ppm of the oligomeric hindered amine light stabilizer (butanedioic acid, dimethylester, polymer with 4-hydroxy-2,2,6,6-tetramethyl-1-piperidine ethanol, CAS 65447-77-0) and the additives listed in Table 1.

Additive loadings are in ppm (parts per million) by weight, based on the weight of the polymer. Additives were blended with grinded polymer powder in a high-speed mixer. Thoroughly blended formulations were melt compounded in a twin-screw extruder at maximum 200° C. under nitrogen. Pelletized samples are processed on laboratory cast film line with die set temperature of 220° C. into 180 micron thick films.

The film samples were exposed to UV-C radiation in a climate chamber equipped with 2 stainless steel lamp racks holding 5 UVC 253.7 nm emitting lamps TUV T8 F17 1SL/25, from Signify GmbH, Hamburg, Germany. The sample holding racks were positioned 13 cm below the lamp racks and the samples were only placed in center of the sample rack (30×40 cm). The conditions in the chamber were maintained at a temperature of 65±3° C. and relative humidity of 20±10% r.h. The irradiance in the range of 250 to 260 nm measured at the level of the sample racks was 28 W/m².

The change in intensity of the C═O absorption (carbonyl absorption) in the IR-spectrum was used to measure the oxidative damage of the polyethylene film sample. The spectra were measured at 1721 cm⁻¹ with the FT-IR Spectrophotometer. The times in hours to reach a carbonyl value of 0.1 were reported in the Table 1.

TABLE 1

| | | time to reach |
|---|---|---|
| Sample | Additives | Carbonyl = 0.1 |
| A | — (Comparative) | 32 h |
| B | 1400 ppm Compound (12) | 67 h |
| C | 1200 ppm Compound (12); | 94 h |
| | 200 ppm Compound (4) | |
| D | 1200 ppm Compound (12); | 71 h |
| | 200 ppm Compound (6) | |
| E | 1400 ppm Compound (9) | 54 h |

The data showed that the additives used in Samples B to E stabilized the film against degradation induced by artificial UV-C light.

### Example 2—HDPE Injection Molding Plaques

A high density polyethylene HDPE (Borealis MG 9641, amount of 99.65 wt %) was formulated with the block oligomeric hindered amine light stabilizer (1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine, CAS 192268-64-7; amount of 0.15 wt % in Sample A and 0.1 wt % in the others), 0.05 wt % calcium stearate and 0.15 wt % blend of tris(2,4-di-tert-butylphenyl)phosphite and pentaerythritol tetrakis(3-(3,5-di-tert-butyl-4-hydroxyphenyl)propionate), and the additives listed in the Table 2.

The formulation components were pre-mixed in a high-speed mixer. Thoroughly blended formulations were melt compounded in a twin-screw extruder at set temperature of 230° C. under nitrogen. Pelletized samples were injection molded to 2 mm thick plaques (44×68 mm) in an Engel HL 60 injection molding machine at 240° C.

The plaques were exposed to the UVC aging device described in example 1. The sample holding racks are positioned 57 cm below the lamp racks and the samples are only placed in center of the sample rack (30×40 cm). The conditions in the chamber were maintained at a temperature of 65±3° C. and relative humidity of 20±10% r.h. The irradiance in the range of 250 to 260 nm measured at the level of the sample racks is 7.7 W/m².

The plaques were tested for change in color (Delta E) with increasing exposure time according to according to DIN EN ISO/CIE 11664-4 with a Datacolor 800 spectrophotometer; aperture of 20 mm. The Delta E values after 12 hours and 18 hours of exposure were summarized in the Table 2.

TABLE 2

| | | Delta E | Delta E |
|---|---|---|---|
| Sample | Additive | after 12 h | after 18 h |
| A | — (Comparative) | 11.3 | 12.5 |
| B | 0.05% Compound (12) | 7.1 | 8.5 |
| C | 0.05% Compound (6) | 7.4 | 8.8 |
| D | 0.05% Compound (7) | 7.4 | 8.8 |

The data showed that the additives used in Samples B to D stabilized the plaques against degradation induced by artificial UV-C light.

### Example 3—PP Molded Films

A PP/TPO (Borealis Daplen EE013AE) is formulated with 0.1 wt % of a blend of 80% tris(2,4-di-tert.-butylphenyl)phosphite and 20% octadecyl-3-(3,5-di-tert-butyl-4-hydroxyphenyl)-propionate, 0.05 wt % of calcium stearate and additives listed in the Table 3.

The formulation components listed were pre-mixed in a high-speed mixer. Thoroughly blended formulations were melt compounded in a twin-screw extruder at set temperature of 230° C. and 1 under nitrogen. Pelletized samples were compression molded to a film of 170 micron thickness, in a press at 230° C. for 3 minutes.

The films were exposed to UVC aging device described in example 1. The sample holding racks were positioned 57 cm below the lamp racks and the samples were only placed in center of the sample rack (30×40 cm). The conditions in the chamber are maintained at a temperature of 65±3° C. and relative humidity of 20±10% r.h. The irradiance in the range of 250 to 260 nm measured at the level of the sample racks was 7.7 W/m².

The measured parameter was the change in intensity of the C═O absorption (carbonyl absorption) measured at 1721 cm⁻¹ with the FT-IR Spectrophotometer Nicolet iN10MX of Thermo Fisher Scientific Inc. The times in hours to reach a carbonyl value of 0.1 were reported in Table 3.

TABLE 3

| | | Time to reach |
|---|---|---|
| Sample | Additives | Carbonyl = 0.1 |
| A | — (Comparative) | 18 h |
| B | 0.05% Compound (12) | 35 h |
| C | 0.05% Compound (7) | 36 h |
| D | 0.05% Compound (16) | 30 h |

The data showed that the additives used in Samples B to D stabilized the films against degradation induced by artificial UV-C light.

### Example 4—ABS Compression Molded Plaques

An ABS (acrylonitrile butadiene styrene copolymer, Terluran GP-22 from INEOS Styrolution, 100 wt %) was formulated with 0.1 wt % of a blend of 80% tris(2,4-di-tert-butylphenyl)phosphite and 20% octadecyl-3-(3,5-di-tert-butyl-4-hydroxyphenyl)-propionate, 0.03 wt % of the hindered amine light stabilizer (N,N′-bis(2,2,6,6-tetramethyl-4-piperidyl)-N,N′-diformylhexamethylene-diamine, CAS 124172-53-8), and the additives listed in Table 4. The formulation components listed were pre-mixed in a high-speed mixer. Thoroughly blended formulations were dried for 3 hours in a vacuum oven at 80° C. prior to melt compounding in a twin-screw extruder at set temperature of 220° C. under nitrogen. Pelletized samples were dried for 3 hours at 80° C. and compression molded to 2 mm thick plaques (50×75 mm) in a press at 220° C. for 3 minutes.

The plaques were exposed to UVC aging device described in example 1. The sample holding racks were positioned 57 cm below the lamp racks and the samples are only placed in center of the sample rack (30×40 cm). The conditions in the chamber were maintained at a temperature of 65±3° C. and relative humidity of 20±10% r.h. The irradiance in the range of 250 to 260 nm measured at the level of the sample racks was 7.7 W/m².

The plaques were tested for change in color (Delta E) with increasing exposure time according to DIN EN ISO/CIE 11664-4 with a Datacolor 800 spectrophotometer; aperture of 20 mm The Delta E values after 12 hours and 18 hours of exposure are summarized in Table 4.

TABLE 4

| | | Delta E | Delta E |
|---|---|---|---|
| Sample | Additive | after 12 h | after 18 h |
| A | — (Comparative) | 5.1 | 7.2 |
| B | 0.03% Compound (11) | 4.2 | 6.2 |
| C | 0.08% Compound (11) | 3.9 | 5.9 |
| D | 0.03% Compound (11) + 0.05% Compound (9) | 3.8 | 5.7 |
| E | 0.03% Compound (11) + 0.05% Compound (10) | 4.1 | 6.1 |
| F | 0.03% Compound (11) + 0.05% Compound (4) | 4.5 | 6.6 |
| G | 0.03% Compound (11) + 0.05% Compound (6) | 4.3 | 6.4 |
| H | 0.03% Compound (11) + 0.05% Compound (7) | 4.4 | 6.6 |
| I | 0.03% Compound (11) + 0.05% Compound (18) | 4.5 | 6.7 |
| J | 0.03% Compound (11) + 0.05% Compound (12) | 4.3 | 6.5 |
| K | 0.03% Compound (11) + 0.05% Compound (15) | 4.8 | 7.0 |
| L | 0.03% Compound (11) + 0.05% Compound (16) | 4.8 | 6.9 |
| M | 0.03% Compound (11) + 0.05% Compound (20) | 4.5 | 6.6 |
| N | 0.03% Compound (11) + 0.10% Compound (10) | 4.3 | 6.4 |
| O | 0.03% Compound (11) + 0.10% Compound (4) | 4.3 | 6.5 |

The data showed that the additives used in Samples B to O of Table 4 stabilized the plaques against degradation induced by artificial UV-C light.

### Example 5—Polycarbonate/ABS Compression Molded Plaques

A PC/ABS (Bayblend T65XF from Covestro, 100 wt %) was formulated with 0.1 wt % of a blend of 80% tris(2,4-di-tert-butylphenyl)phosphite and 20% octadecyl-3-(3,5-di-tert-butyl-4-hydroxyphenyl)-propionate, and the additives listed in the below Table 5. The formulation components were pre-mixed in a high-speed mixer. Thoroughly blended formulations were dried for 3 hours in a vacuum oven at 80° C. prior to melt compounding in a twin-screw extruder at set temperature of 250° C. under nitrogen. Pelletized samples were dried for 4 hours at 120° C. before compression molded to 2 mm thick plaques (50×75 mm) in a press at 250° C. for 3 minutes.

The plaques were exposed to UVC aging device described in example 1. The sample holding racks were positioned 57 cm below the lamp racks and the samples are only placed in center of the sample rack (30×40 cm). The conditions in the chamber were maintained at a temperature of 65±3° C. and relative humidity of 20±10% r.h. The irradiance in the range of 250 to 260 nm measured at the level of the sample racks was 7.7 W/m².

The plaques were tested for change in color (Delta E) with increasing exposure time according to according to DIN EN ISO/CIE 11664-4 with a Datacolor 800 spectrophotometer; aperture of 20 mm. The Delta E values after 12 hours and 18 hours of exposure are summarized in the Table 5.

TABLE 5

| | | Delta E | Delta E |
|---|---|---|---|
| Sample | | after 12 h | after 18 h |
| A | — (Comparative) | 6.5 | 7.9 |
| B | 0.05 wt % Compound (10) | 5.9 | 7.4 |
| C | 0.1 wt % Compound (10) | 5.8 | 7.1 |
| D | 0.05 wt % Compound (4) | 5.5 | 6.9 |
| E | 0.1 wt % Compound (4) | 5.8 | 7.1 |

The data showed that the additives used in Samples B to E of Table 5 stabilized the plaques against degradation induced by artificial UV-C light.

1. A method for stabilizing a shaped polymer article against degradation induced by artificial UV-C light, comprising incorporating into the shaped polymer article a stabilizer selected from 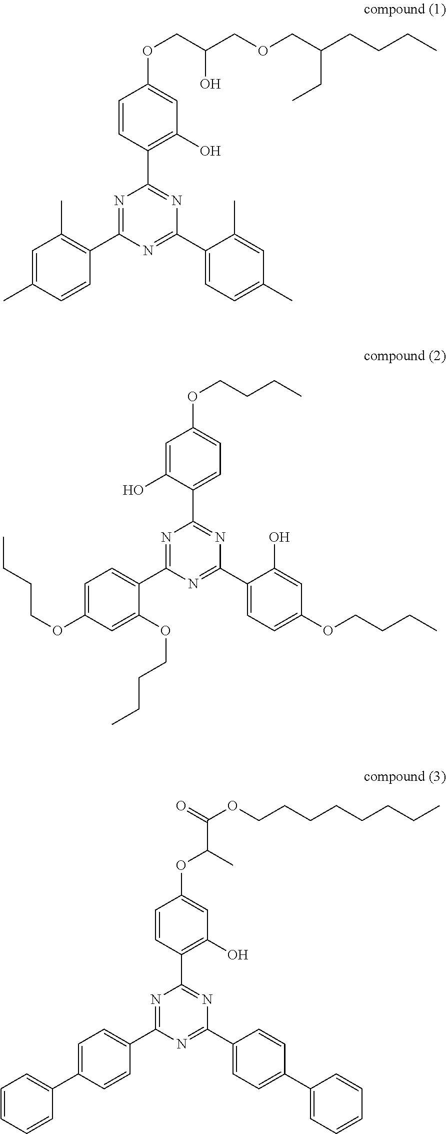 [SMILES: CCCCC(CC)COCC(O)COc1ccc(-c2nc(-c3ccc(C)cc3C)nc(-c3ccc(C)cc3C)n2)c(O)c1 ; CCCCOc1ccc(-c2nc(-c3ccc(OCCCC)cc3O)nc(-c3ccc(OCCCC)cc3OCCCC)n2)c(O)c1 ; CCCCCCCCOC(=O)C(C)Oc1ccc(-c2nc(-c3ccc(-c4ccccc4)cc3)nc(-c3ccc(-c4ccccc4)cc3)n2)c(O)c1] 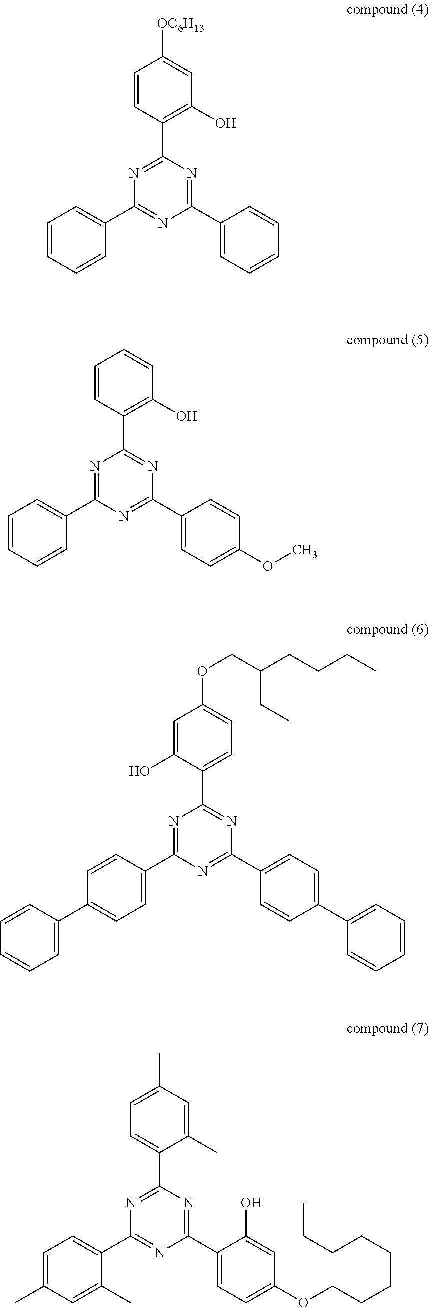 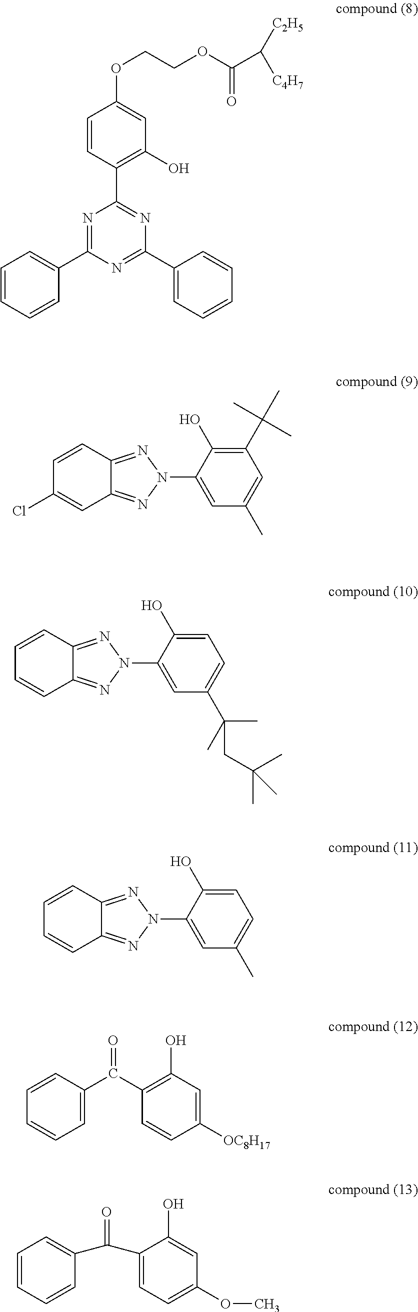 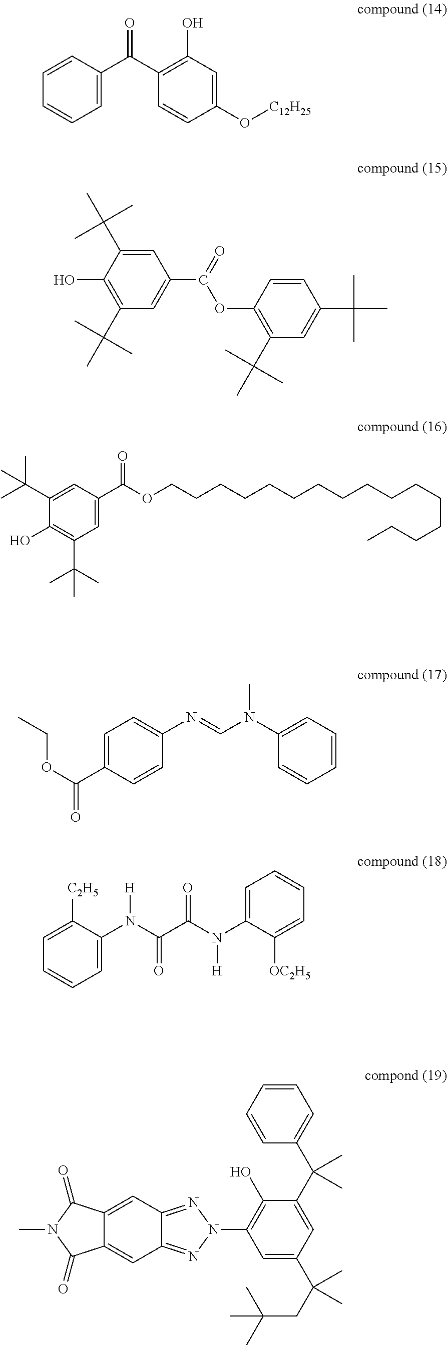 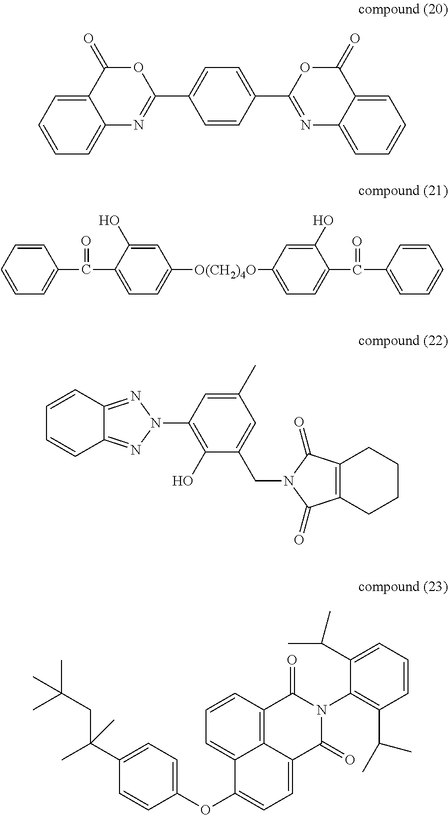
or
micronized metal oxide salts.

2. The method according to claim 1, wherein the stabilizer is selected from
compound (6),
compound (7),
compound (10),
compound (11),
compound (12),
compound (16),
a mixture of compound (12) and compound (4),
a mixture of compound (11) and compound (9), or
a mixture of compound (11) and compound (10).

3. The method according to claim 1, wherein the shaped polymer article is made of a synthetic polymer.

4. The method according to claim 1, wherein the stabilizer is compound (4) and the shaped polymer article is made of polystyrenes, acrylonitrile butadiene styrene copolymers, polycarbonates, polyvinyl chlorides, polyamides or polyethylene terephthalates.

5. The method according to claim 1, wherein the stabilizer is selected from compound (12), compound (4), compound (6), compound (7), compound (16), or a mixture of compound (12) or compound (4), and the shaped polymer article is made of polyethylenes or polypropylenes.

6. The method according to claim 1, wherein the stabilizer is selected from compound (4), compound (10), compound (11), a mixture of compound (11) and compound (9), or a mixture of compound (11) and compound (10), and the shaped polymer article is made of acrylonitrile butadiene styrene copolymers.

7. The method according to claim 1, wherein the stabilizer is selected from compound (4) or compound (10), and the shaped polymer article is made of polycarbonate and acrylonitrile butadiene styrene copolymer.

8. The method according to claim 1, wherein the degradation by UV-C light is induced by UV-C disinfection against microorganism of the shaped polymer article.

9. The method according to claim 1, wherein the degradation by UV-C light is induced frequently.

10. The method according to claim 1, wherein a dose of at least 100 μW·s/cm² within 24 his received at the surface of the shaped polymer article.

11. The method according to claim 1, wherein the degradation by UV-C light is induced indoors.

12. The method according to claim 1, wherein the UV-C light has a wavelength from 200 to 275 nm.

13. The method according to claim 1, wherein the shaped polymer article comprises 0.01-1 wt % of the stabilizer.

14. The method according to claim 1, wherein the stabilizer is present inside the shaped polymer article.

15. The method according to claim 1, wherein a non-porous surface of the shaped polymer article is stabilized against the degradation.

16. The method according to claim 1, wherein a non-transparent surface of the shaped polymer article is stabilized against the degradation.

17. (canceled)

18. The method according to claim 1, wherein the shaped polymer article is made of polyethylenes, polypropylenes, polystyrenes, acrylonitrile butadiene styrene copolymers, polycarbonates, polyvinyl chlorides, polyamides or polyethylene terephthalates.

19. The method according to claim 1, wherein the degradation by UV-C light is induced at least once a week.

20. The method according to claim 1, wherein the degradation by UV-C light is induced in public buildings, industrial offices, industrial production buildings, private buildings, or in transport vehicles.

21. The method according to claim 1, wherein the shaped polymer article comprises 0.1-0.5 wt % of the stabilizer.
